(19) United States
(12) Patent Application Publication
(10) Pub. No.: US 2014/0279706 A1
(43) Pub. Date: Sep. 18, 2014

(54) PRINT-ON-DEMAND AUTHORIZATION AND RETRIEVAL FOR THIRD PARTY PRINT SHOPS USING STANDARDIZED TWO-DIMENSIONAL BARCODE LOOK-UP

(71) Applicant: Kevin Blasko, Burlingame, CA (US)

(72) Inventor: Kevin Blasko, Burlingame, CA (US)

(73) Assignee: KONICA MINOLTA LABORATORY U.S.A., INC., San Mateo, CA (US)

(21) Appl. No.: 13/834,236

(22) Filed: Mar. 15, 2013

(51) Int. Cl. G06Q 30/06; G06Q 30/02; G06K 15/02

(52) U.S. Cl. CPC G06Q 30/0613; G06K 15/1889; G06Q 30/0283
USPC 705/400; 358/1.18; 358/1.15

(57) ABSTRACT

A method for managing printing a hard copy of a work from a digital copy of the work, including the steps of a content provider of the digital copy of the work dynamically generating a standardized two-dimensional barcode when the digital copy of the work is produced for a user acquiring rights to the digital copy of the work, the barcode containing a unique URL of the content provider and being embedded in a portion of the digital copy of the work where digital rights management protection is omitted; and a print shop scanning the barcode from the digital copy of the work provided by the user to be readily linked to the content provider, and obtaining authorization and royalty information for printing the hard copy of the work for the user.

### BACKGROUND OF THE INVENTION

1. Field of the Invention

This invention relates to a method of managing print-on-demand (POD) jobs by third party print shops, and in particular, it relates to authorization and retrieval of POD jobs for third party print shops.

2. Description of Related Art

Increasingly, traditional documents, books and other publications printed on hard paper copies are prepared, transmitted and presented in digital files now. For example, a reader may purchase a book online and receive a digital copy of the book via online transmission.

Typically the rights associated with hard paper copies and electronic digital copies of a book are different, resulting in different royalty calculations and final pricing. A reader who has purchased a digital copy of a book may not necessarily have the rights to print by him or herself a hard copy of the book. Oftentimes the digital copy of the book will be embedded with codes preventing unauthorized printing of the book into hard copies. If the reader has purchased the rights for both the digital and hard copies of the book, then the reader may be allowed to print a limited number of hard copies of the book.

It will be beneficial to provide an easy way for the third party printers and print shops to handle a POD job for a reader to convert his or her digital copy into a hard copy while still abiding by copyright laws.

### SUMMARY

The conventional approach of allowing a reader to print by him or herself a hard copy of a document, book or publication from his or her digital copy may be problematic. First, restricting the number of times the reader may print a hard copy is difficult and the restriction code may be broken. Second, it is not always convenient or even possible for the reader to go back to the provider of the digital copy to obtain a print of the hard copy as the provider may not necessarily also be a print shop. Oftentimes the reader needs to use a third party printer or print shop to do a POD job for printing one or more hard copies.

In fact it is preferable that a reader would use a commercial printer or print shop to print the hard copies of a document, book or publication from a digital copy. Commercial printers and print shops have the facilities and capacities to handle POD jobs and are far less likely to abuse the copyright restrictions by printing extra hard copies without paying the correct royalty. However, these third party printers or print shops are not necessarily associated or partnered with the provider of the digital copy.

The embodiments of present invention are directed to a new method of facilitating third party printers and print shops to handle a POD job for a reader to convert his or her digital copy into a hard copy while fulfilling all applicable royalty payment obligations under the copyright laws.

Some embodiments of the present invention provide a method for authorizing a third party printer or print shop to do a POD job for a reader that produces a hard copy of a digital file that the reader has acquired.

Some embodiments of the present invention also provide a method for allowing a third party printer or print shop to produce a hard copy of a digital file that the reader has acquired when the copyright royalty obligation is fulfilled.

Some embodiments of the present invention additionally provide a method for facilitating the retrieval of files and information that enable a third party printer or print shop to produce a hard copy of a digital file with the right pricing to a reader who has already acquired the rights to the digital file.

Some embodiments of the present invention further provide a method for POD authorization and retrieval for third party print shops using a standardized two-dimensional barcode (such as a Quick Response or “QR” code) look-up to convert a reader's digital copy into a hard copy with correct royalty paid.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, one of the exemplary embodiments of the present invention provides a method for managing printing a hard copy of a work from a digital copy of the work, including the steps of a content provider of the digital copy of the work dynamically generating a standardized two-dimensional barcode when the digital copy of the work is produced for a user acquiring rights to the digital copy of the work, the barcode containing a unique Uniform Resource Locator (URL) of the content provider and being embedded in a portion of the digital copy of the work where digital rights management protection is omitted; and a print shop scanning the barcode from the digital copy of the work provided by the user to be readily linked to the content provider, and obtaining authorization and royalty information for printing the hard copy of the work for the user.

In a further aspect, another one of the exemplary embodiments of the present invention provides a computer software program product that causes a data processing apparatus to perform the above described methods. The computer program product includes a computer usable non-transitory medium (e.g. memory or storage device) having a computer readable program code embedded therein for controlling a data processing apparatus, the computer readable program code configured to cause the data processing apparatus to execute the above described processes.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic block diagram illustrating an exemplary online environment according to one of the embodiments of the present invention.

FIG. 2 is a schematic block diagram illustrating an exemplary data processing apparatus such as a computer or server having a data processing unit according to one of the embodiments of the present invention.

FIG. 3 is a schematic block diagram illustrating an exemplary data processing apparatus such as a printer or copier having a data processor or controller unit according to the embodiment of the present invention.

FIG. 4 is a flow chart diagram illustrating an exemplary process according to one of the embodiments of the present invention.

### DETAILED DESCRIPTION OF PREFERRED EMBODIMENTS

Embodiments of the present invention provide a method for facilitating third party printers and print shops to print a hard copy of a digital file for a user who has acquired the rights to the digital file, while satisfying all applicable copyright obligations. This method allows a user to print a hard copy of a document, book, publication or the like for which the user has only previously purchased digital viewing rights, even in the instances when the digital rights management (DRM) of the digital file has disabled such functionality.

For example, a user has purchased a digital booklet in which the DRM has deactivated all other distribution options. Implementing the embodiments of the present invention, the deactivation can be over-written and support for a printed version can be enabled. It is understood that an additional licensing fee or royalty may be due to the copyright owner and the embodiments of the present invention have addressed this issue as well.

In addition, the embodiments of the present invention also allow a print shop who has no prior association or partnership with the provider of the digital file to authorize, obtain and print a hard copy of the digital file. With minimal effort the print shop will be able to help customers while making a just profit.

Referring to FIG. 1, there is shown a schematic block diagram illustrating an exemplary arrangement 10 in which various embodiments of the present invention may be implemented. The exemplary environment 10 includes reader, customer or user 20, a content provider 30 such as a publisher, a book store, or an educational institute, a printer or print shop 40, and a DRM center 50, all connected through a network 60 which may include a computer network such as the Internet or other communication links.

When computer network such as the Internet is utilized, a reader, customer or user 20 may use a computer or terminal, or similar suitable devices such as a laptop computer, a tablet computer, an e-reader, or a smart phone, etc., to access the computer network and interact with the content provider 30 and the third party print shop 40, etc. An administrator or operator of the content provider 30 may use a computer server to access the network and interact with the reader, customer or user 20, the third party print shop 40 and the DRM center 50. Likewise, a manager or operator of the third party print shop 40 may use a servers to access the network and interact with the user 20, the content provider 30, etc.

The content provider 30 generally provides documents, books, booklets, publications and other materials in digital or hard copies. The content provider 30 may provide an integrated online service that allows users to search, access, upload or download, and purchase documents stored as electronic digital files in internal or external file storages or databases. When a content or work is purchased in either hard or digital copy or both, the content provider will factor the copyright license fee and/or royalty into the pricing. The content provider 30 may contact and obtain copyright license fee and/or royalty payment information from the DRM center 50.

The print shop or printer 40 may be a professional print shop equipped with printing systems and various other image reproduction machines for producing printed products such as books, booklets, and other printed publications, etc. The print shop or printer 40 may handle POD job orders from the user 20 to produce printed products. The user 20 may interact with the print shop 40 online through a computer network such as the Internet, or the user may visit the print shop's physical facilities in person as indicated by the dotted line 22 in FIG. 1.

The computers, terminals and servers used by the user 20, the content provide 30, the print shop 40 and the DRM center 50 may be computers, server computers, or computer or server systems, such as webservers, where the computer software program(s) and/or application(s) implementing the various processes of the exemplary embodiments of the present invention may be installed and executed.

Typically these computers and servers provide a user interface (UI) or graphic user interface (GUI) to allow users or operators to interact with the computer software programs and applications to perform various steps of the process.

In this Application the term “server” generally refers to any computer, server, server computer, server instance, computer or server system, data processor, controller, data processing unit or apparatus, or any suitable system, apparatus or device, and any computer software program or application that are installed or executed on such system, apparatus or device, that may be used to implement the methods or carry out the processes provided by the embodiments of the present invention.

A user typically accesses the computers and server by using computer programs or applications on the users' own computer or on a server that the user can access through a user computer or terminal.

In this Application the term “user” generally refers to anyone who uses the method or related apparatus provided by the embodiments of the present invention.

In addition, in this Application the terms “user” and the server user by the user, or “content provider” and the server used by the content provider, or “print shop” and the server used by the print shop, or “DRM center” and the server used by the DRM center, may be used interchangeably respectively to refer to such person or entity who uses a server and/or a server that is used by such person or entity to carry out the steps of the process according to the various embodiments of the present invention.

The physical locations or the commercial relationship among the various parts of the environment shown in FIG. 1 are not important. For example, the server of the content provider may be located at the print shop, or a separate institution, organization or commercial establishment.

As mentioned earlier, in one aspect, an exemplary embodiment of the present invention is a computer program product that causes a data processing apparatus to perform the exemplary embodiments of the methods of the present invention. The computer program product includes a computer usable non-transitory medium (e.g. memory or storage device) having a computer readable program code embedded therein for controlling a data processing apparatus, where the computer readable program code is configured to cause the data processing apparatus to execute the process of the present invention as shown in FIG. 2.

Referring to FIG. 2, there is shown a schematic block diagram illustrating an exemplary server 100, whereupon various embodiments of the present invention may be implemented. The server 100 typically includes a user input device 110 including, for example, a keyboard and a mouse. The input device 110 may be connected to the server 100 through a local input/output (I/O) port 120 to enable an operator and/or user to interact with the server 110. The local I/O 120 is also provided for local connections via direct links to other electronic devices such as a file storage, a monitor and/or a printer. The server 100 typically also has a network I/O port 130 for connection to a computer network such as the Internet, so that the server 100 may remotely communicate with the other servers connected to the computer network.

The server 100 typically has a data processor/controller unit 140 such as a central processor unit (CPU) that controls the functions and operations of the server 100. The data processor/controller unit 140 is connected to various memory devices such as a random access memory (RAM) device 150, a read only memory (ROM) device 160, and a storage device 170 such as a hard disc drive or solid state memory. The storage device 170 may be an internal memory device or an external memory device such as a file storage device.

The computer software program codes and instructions for implementing the various embodiments of the present invention may be installed or saved on one or more of these memory devices. The data processor/controller unit 140 executes these computer software programs and instructions to perform the functions and carry out the operations to implement the process steps of the various embodiments of the present invention.

The server 100 typically also includes a display device 180 such as a video monitor or display screen which may be connected to the local I/O 120. The input device 110 and the display device 180 together provide a user interface (UI) which allows a user to interact with the server 100 to perform the steps of the process according to the various embodiments of the present invention.

The input device 110 and the display device 180 may be integrated into one unit, such as a touch screen display unit, to provide a more easy and convenient UI for user interaction with the server 100.

It is understood that the server 100 may be any suitable computer or computer system. Preferably for use, for example, by an online service provider, the server 100 is a webstore server. However, for use by a member of the general public, the server 100 may be a desktop computer, a laptop computer, a notebook computer, a netbook computer, a tablet computer, a hand-held portable computer or electronic device, a smart phone, or any suitable data processing apparatus that has suitable data processing capabilities.

Referring to FIG. 3, there is shown a schematic block diagram illustrating another exemplary data processing apparatus embodied in a document reproduction device such as a printer or copier 200, whereupon various embodiments of the present invention may also be implemented.

The printer or copier 200 typically includes an integrated control panel 210 which includes a keypad and a display screen, or a touch screen that provides both the input and display functions.

The printer or copier 200 may has a local I/O port 220 for connection with other local devices such as a computer. The printer or copier 200 typically also has a network I/O port 230 for connection to a network such as the Internet so that the printer or copier 200 may remotely communicate with the other computers and servers connected to the Internet.

The printer or copier 200 typically has a data processor/controller unit 240 that controls the functions and operations of the printer or copier 200. The data processor/controller unit 240 is connected to various memory devices such as a RAM device 250, a ROM device 260, and a storage device 270 such as a hard disc drive or solid state memory.

The storage device 270 may be an internal memory device or an external memory device such as a hard disc drive. The computer software programs and instructions for implementing the various embodiments of the present invention may be installed or saved on one or more of these memory devices.

The data processor/controller unit 240 executes these computer software programs and instructions to perform the functions and carry out the operations to implement the process steps of the various embodiments of the present invention.

It is understood that the data processing apparatus 200 may be any suitable document reproduction device or system, such as a printer, a copier, a scanner, a facsimile machine, an all-in-one printer, a printing system, or any suitable document reproduction device that has suitable data processing capabilities.

Referring to FIG. 4, there is shown a flow chart diagram illustrating an exemplary process in accordance with to one of the embodiments of the present invention. The process begins at Step S10, wherein a standardized two-dimensional barcode (such as a QR code) containing a content provider's unique URL is dynamically generated when a digital copy of a work (e.g., a document, a book, a booklet, a publication, etc.) is produced. At Step S12 this barcode is embedded into the digital copy of the work, e.g., on a page such as the cover page or the table of contents (TOC) page. These pages will be omitted from any DRM protection since they typically do not contain copyrighted works. Because these pages are omitted they will be visible even when DRM has disabled or limited the functionalities of the digital copy of the work. Steps S10 and S12 may be performed by the provider server, however one or both of the steps may also be performed by the DRM center server.

At Step S14 a user acquires the digital copy of the work, wherein DRM may have disabled or limited certain functionalities. For example, when the user only acquires the rights to digitally view the digital copy, then the rights to print out the work in hard copy from the digital copy may be disabled. Step S14 may be performed by the user computer.

However, the user may subsequently have a need to obtain a hard copy of the work by printing out the digital copy. If so, at Step S16 the user can present the digital copy to a print shop. This can be done either online or offline (as indicated in FIG. 1). For example, the user may email the digital copy to the print shop or upload the digital copy online to the print shop's website. Step S14 may be performed by the user computer if performed online. Alternatively, the user may visit the print shop in person and show the digital copy on the user's laptop to the print shop personnel or give a thumb-drive containing the digital copy to the print shop's personnel.

At Step S18 the print shop may scan the barcode from the user's digital copy of the work. Once scanned the URL will redirect the print shop to a website of the content provider at Step S20. At Step S22 the print shop can provide its credentials to the content provider and seamlessly obtain authorization to print the hard copy of the work. Steps S18 through S22 may be performed by the print shop server.

At Step S24 the content provider provides information on royalty (for printing the hard copy) to the print shop. Such information may be obtained from a DRM center or other copyrights management centers. Step S24 may be performed by the provider server or the DRM center server.

After obtaining the royalty information, at Step S26 the print shop can calculate the costs for printing the hard copy, including the royalty. At Step S28 the print shop informs the user of the price for printing the hard copy as determined by the print shop. Steps S26 and S28 may be performed by the print shop server.

Once the user agrees to the price at Step S30, the print shop can print the hard copy for the user at Step S32. Step S30 may be performed by the user computer, and S32 may be performed by the print shop server. The hard copy may be printed from the digital copy provided by the user or from a digital copy retrieved from the content provider's website or otherwise provided by the content provider.

The various embodiments of the present invention method have many advantages. They provide a method for authorizing a third party printer or print shop to do a POD job for a reader that produces a hard copy of a digital file that the reader has acquired. They also provide a method for allowing a third party printer or print shop to produce a hard copy of a digital file that the reader has acquired when the copyright royalty obligation is fulfilled. In addition, they provide a method for facilitating the retrieval of files and information that enable a third party printer or print shop to produce a hard copy of a digital file with the right pricing to a reader who has already acquired the rights to the digital file. Furthermore, they provide a method for POD authorization and retrieval for third party print shops using a standardized two-dimensional barcode look-up to convert a reader's digital copy into a hard copy with correct royalty paid.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

What is claimed is:

1. A method for managing printing a hard copy of a work from a digital copy of the work, comprising the steps of:
a content provider of the digital copy of the work dynamically generating a standardized two-dimensional barcode when the digital copy of the work is produced for a user acquiring rights to the digital copy of the work, the barcode containing a unique URL of the content provider and being embedded in a portion of the digital copy of the work where digital rights management protection is omitted; and
a print shop scanning the barcode from the digital copy of the work provided by the user to be readily linked to the content provider, and obtaining authorization and royalty information for printing the hard copy of the work for the user.

2. The method of claim 1, wherein the URL links the print shop to a website of the content provider.

3. The method of claim 1, wherein the digital copy of the work is provided by the user to the print shop online.

4. The method of claim 1, wherein the digital copy of the work is provided by the user to the print shop offline.

5. The method of claim 1, further comprising a step of the print shop presenting its credential to the content provider.

6. The method of claim 1, further comprising a step of the print shop calculating a price for printing the hard copy of the work, wherein the price including the royalty for printing the hard copy of the work.

7. The method of claim 6, wherein the price includes a royalty for printing the hard copy of the work.

8. The method of claim 1, further comprising a step of the print shop printing the hard copy of the work.

9. The method of claim 8, wherein the hard copy of the work is printed from the digital copy of the work provided by the user.

10. The method of claim 8, wherein the hard copy of the work is printed from a digital copy of the work retrieved by the print shop from the content provider.

11. A computer program product comprising a non-transitory computer usable medium having a computer readable code embodied therein for controlling a data processing apparatus, the computer readable program code configured to cause the data processing apparatus to execute a process for managing printing a hard copy of a work from a digital copy of the work, the process comprising the steps of:
a content provider of the digital copy of the work dynamically generating a standardized two-dimensional barcode when the digital copy of the work is produced for a user acquiring rights to the digital copy of the work, the barcode containing a unique URL of the content provider and being embedded in a portion of the digital copy of the work where digital rights management protection is omitted; and
a print shop scanning the barcode from the digital copy of the work provided by the user to be readily linked to the content provider, and obtaining authorization and royalty information for printing the hard copy of the work for the user.

12. The computer program product of claim 11, wherein the URL links the print shop to a website of the content provider.

13. The computer program product of claim 11, wherein the digital copy of the work is provided by the user to the print shop online.

14. The computer program product of claim 11, wherein the digital copy of the work is provided by the user to the print shop offline.

15. The computer program product of claim 11, wherein the process further comprises a step of the print shop presenting its credential to the content provider.

16. The computer program product of claim 11, wherein the process further comprises a step of the print shop calculating a price for printing the hard copy of the work, wherein the price including the royalty for printing the hard copy of the work.

17. The computer program product of claim 11, wherein the price includes a royalty for printing the hard copy of the work.

18. The computer program product of claim 11, wherein the process further comprises a step of the print shop printing the hard copy of the work.

19. The computer program product of claim 18, wherein the hard copy of the work is printed from the digital copy of the work provided by the user.

20. The computer program product of claim 18, wherein the hard copy of the work is printed from a digital copy of the work retrieved by the printer from the content provider.
